(19) United States
(12) Patent Application Publication
(10) Pub. No.: US 2018/0058668 A1
(43) Pub. Date: Mar. 1, 2018

(54) CAPTIVE RETAINING SPRING

(71) Applicant: PHILIPS LIGHTING HOLDING B.V., EINDHOVEN (NL)

(72) Inventor: JOHN PARK, FALL RIVER, MA (US)

(21) Appl. No.: 15/681,963

(22) Filed: Aug. 21, 2017

Related U.S. Application Data
(60) Provisional application No. 62/382,118, filed on Aug. 31, 2016.

(30) Foreign Application Priority Data
Sep. 22, 2016 (EP) 16190205

(51) Int. Cl. F21V 21/04

(52) U.S. Cl. CPC F21V 21/045; F16F 1/025

(57) ABSTRACT

A captive retaining spring for a recessed mounting assembly has a retaining spring which is adjustable to compensate for multiple surface thicknesses, does not require the use of tools for installation, and may be assembled by the manufacturer and shipped ready for installation.

### FIELD OF THE INVENTION

The present invention relates generally to recessed enclosures, and more particularly to a retaining spring for a recessed enclosure which is adjustable for varying surface (e.g. ceiling) thicknesses, may be installed without the use of tools, and may be assembled with the recessed enclosure by the manufacturer prior to shipment of the recessed enclosure assembly.

### BACKGROUND OF THE INVENTION

Recessed enclosures, such as, speaker systems, sensors, downlight fixtures, etc. have become increasingly popular for residential and commercial use. One reason for the increased popularity is that the recessed downlight fixtures meet a wide range of interior lighting requirements while also being aesthetically pleasing. Recessed lighting fixtures or downlights provide lighting for an area and are aesthetically pleasing due in part to the unobtrusive nature of the fixtures themselves which are typically recessed within the surface. Further, recessed downlight fixtures may be installed in new constructions as well as existing surfaces and therefore are valued by installers. Recessed luminaires often require some sort of mounting method for the finishing section. Various building codes and architectural detail of a particular space could lead to thick surfaces sometimes as many as 4 layers of 0.625″ plaster sheet material. Often, recessed luminaires have a lower range of surface thickness adaptability, which leads to adapter kits or simply not able to service. Moreover, recessed downlight fixtures typically comprise a frame-in kit with means for securing the frame to structural supports. For installation, the frame of the light fixture may include holes and or brackets through which fasteners are positioned to attach the fixture to the frame.

A support system is often employed to suspend a recessed lighting fixture assembly between adjacent supports. Conventional downlights may be installed between surface joists or from suspended surface grids. Although surface thickness may change in various installations, the recessed lighting assembly must be easily adaptable for use from one installation to another. Heretofore, recessed lighting retaining devices have utilized various devices to adapt for various surface thicknesses. For example, recessed luminaire trims can be held into the surface by spring force. Two spring force methods include friction and torsion springs. Friction springs require multiple leaf springs with teeth detail to be mounted on a frame-in-kit around the aperture. Once the trim is inserted into the aperture, the teeth from the leaf springs will start to grip and bite into the lowest and widest part of the trim. The disadvantage of this method is that the spring force is not pulling the trim into the aperture, and it is also limiting the surface thickness option. Thicker the surface, the less likely it would have a good grip of the trim. Torsion springs require a pair of V-shaped springs in combination of torsion spring receivers. Spring receivers are typically part of frame-in-kit or new construction housing. V-shaped springs are mounted on trim section. V-shaped springs and spring receivers are paired at the ideal height for best pulling mechanism. For thicker surfaces, spring receivers have to be adjusted to accommodate for the difference. However, many of these devices may not be assembled prior to installation. Moreover, many of these structures require an installer to use various tools to assemble the retaining structures to the recessed lighting can for support above surfaces. Some common problems with existing methods include, always needing a frame-in-kit to be paired with a trim, and not having an option for surfaces thicker than 1.5″. The retaining structures cannot be assembled by the manufacturer prior to shipment of the product and installation. This is cumbersome, time consuming to install, and not desirable for installers.

Given the foregoing, it will be appreciated that a retaining device is needed which allows assembly by the manufacturer, functions with various surface thicknesses, and allows installation without the use of tools.

The present invention improves the support system to suspend a recessed lighting fixture by completely moving all the mounting mechanism to the trim side only, the frame-in-kit side no longer have to include any springs or receivers. In fact, it could work without frame-in-kits. Also, the biggest gain from moving all the mechanism to the trim section is that surface thickness adjustment can be made at the trim level, and no adjustment required on the frame. With height adjustable springs on the trim section, it could work with various surface thickness.

### SUMMARY OF THE INVENTION

According to a first exemplary embodiment, a recessed mounting assembly comprises a recessed enclosure having an upper and lower trim. A retaining spring having a guide rail with an adjustment portion coupled to said trim, a support spring having a first end adjustably coupled to the adjustment portion of the guide rail, and a second end, the second end being forcibly adjustable. The retaining spring being adjustable without the use of tools. The retaining spring is adjustable for varying surface thicknesses. The retaining spring causes a force substantially parallel to the longitudinal axis of said recessed enclosure. The spring applies force to a surface a spaced distance from a surface aperture edge. The downward force of the adjustable spring pulls the recessed enclosure to upwards and outwards. Additionally the lower trim can be used to stop the upward movement of the recessed enclosure to the proper surface level. The support spring's second elastic end projects outward to the surface plane. The adjustment portion in guide rail includes slots or other mechanical detail to engage the adjustment portion in the guide rail, for example indents and the like. The support spring has at least one finger at the first end to engage the adjustment portion guide's slots to provide an upper position limiting feature for the captive retaining spring.

According to a second exemplary embodiment, a tool-less surface mounting assembly for a recessed enclosure comprises an enclosure having a trim, a captive retaining spring extending from the enclosure, the captive spring being adjustable in the recessed lighting can for use with various surface thicknesses, the captive spring applying a substantially vertical retaining force. The tool-less surface mounting assembly further comprises a guide coupled to said trim and a support spring that engages the guide. The guide has a spring adjustment area wherein a spring may be adjustably retained. The spring adjustment area receives a first end of the support. The first end of the support spring adjustable in a vertical direction.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of a recessed lighting assembly;

FIG. 2 is a perspective view of a captive retaining spring for the recessed lighting assembly of FIG. 1;

FIG. 3 is a perspective side view of the captive retaining spring of FIG. 2 fully inserted in the recessed lighting assembly;

FIG. 4 is a perspective view of support spring of the captive retaining spring of FIG. 1.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

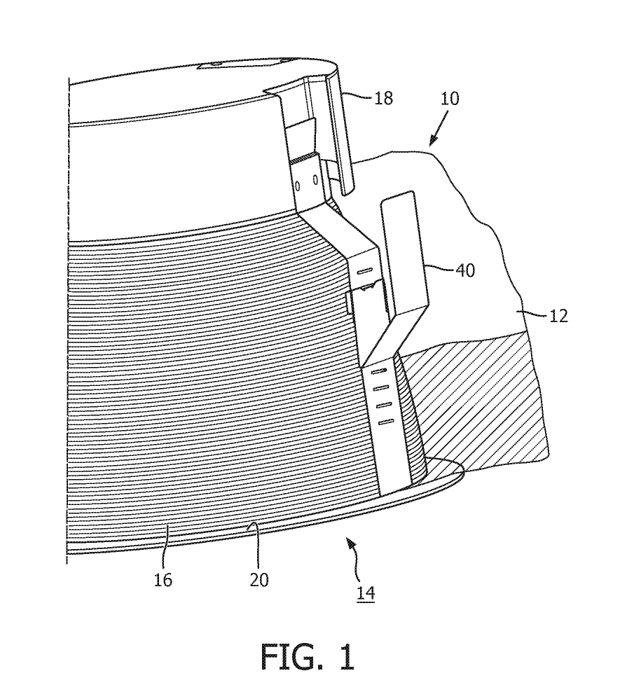

Referring now in detail to the drawings, wherein like numerals indicate like elements throughout the several views, there are shown in FIGS. 1-3 various aspects of a captive retaining spring for a recessed enclosure. The retaining spring may be adjustable to compensate for multiple surface thicknesses, does not require the use of tools for installation, and may be assembled by the manufacturer. Further the present invention is described with reference to a recessed lighting can (e.g. trim/reflector+light engine combo), but may alternatively be utilized with a ventilation system, a smoke detector, a security system, other recessed electrical device requiring a housing or the like.

Referring initially to FIG. 1, a recessed lighting assembly 10 is depicted in perspective view and mounted generally above a surface structure 12. For reason of clarity, the recessed lighting hanger bars are not shown. One skilled in the art will realize that such hanger bars are generally connected between surface joists or suspended surface grid members. The hanger bars are generally adjustable lengthwise to allow installation between varying joist distances or from surface grids of various size. The surface structure 12 is partially cut away in sectional view to reveal the recessed lighting assembly therein. The surface structure 12 may be, for example, a fixed surface of drywall or plaster, or a removable surface panel. The recessed lighting assembly comprises a recessed lighting can or recessed enclosure 14. The recessed enclosure 14 may be formed of various materials such as steel, galvanized steel, aluminum, fiberglass, laminates, composites or other lightweight rigid material for retaining electrical components and elements between structural members, such as hanger bars. The exemplary recessed enclosure 14 is substantially cylindrical in shape as defined by sidewall 16 with upper and lower trim 18, 20. At the upper trim 18 of the recessed enclosure 14 is a closed end top which substantially closes the cylindrical recessed enclosure 14.

Interior of the trim 18, various electrical components are located for providing illumination are provided. Such components include a heatsink, socket (not shown) which receives a lamp, LED illumination components, drivers, etc. Various types of lamps may be utilized such as incandescent, fluorescent, compact fluorescent, halogen, quartz, LED and others known to one skilled in the art. If desirable a reflector may be utilized within the recessed enclosure 14. In this exemplary case, the recessed enclosure 14 is a reflector, the upper portion of guide-rail spring is directly mounted to the reflector neck, and the upper detail of this spring locks on the heatsink assembly.

Along the sidewall 16 of the recessed enclosure 14 is at least one captive retaining spring 40. According to one exemplary embodiment, the recessed enclosure 14 utilizes two retaining springs 40 spaced substantially equidistantly about the periphery of the recessed enclosure 14. The springs 40 are captured between the surface and the engagement with the recessed enclosure 14. The captive retaining springs 40 provide a substantially vertical downward force on the upper surface of surface 12 in order to retain the recessed enclosure 14 in position extending through the surface aperture 13 of surface 12. The captive retaining springs 40 are adjustable in order to allow easy installation regardless of the surface thickness. Specifically, the captive retaining springs 40 are adjustable in a vertical direction. The captive retaining springs 40 may be shipped from the manufacturer in an assembled position and may be installed to retain the recessed enclosure 14 in its desired position without the use of tools as required by many prior art devices. The captive retaining springs 40 is coupled to at least one of the upper or lower trim 18, 20.

Since the captive retaining springs 40 provide a downward force on the upper surface of the surface 12, lower trim 20 captures the surface 12 to fully retain the recessed enclosure 14 in its desired position relative to the lower surface of surface 12. The lower trim 20 may be formed of various lightweight rigid materials and may be fastened or otherwise affixed to the sidewall 16.

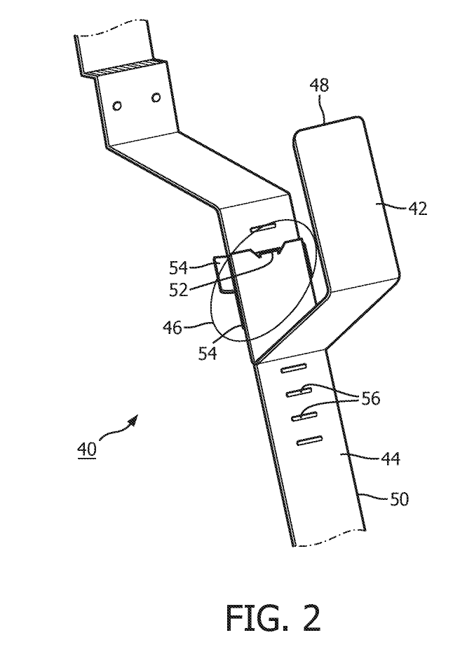

Referring now to FIG. 2, a perspective view of the retaining spring 40 is depicted in a generally vertical orientation, as located in the recessed enclosure 14. The captive retaining spring 40 comprises a support spring 42 and a guide rail 44. The guide rail 44 having an adjustment portion 50. The support spring 42 having a first end 46 adjustably coupled to the adjustment portion 50 of guide rail 44, and second elastic end 48 extending outwardly from the first end 46. The exemplary retaining spring 40 is formed of a thin resilient metal which may bend to provide force on the surface 12. As shown, the support spring 42 includes a section that projects outwardly in a diagonal direction in relation to the guide rail 44. The diagonal direction of the support spring 42 enables it to provide a squeezing and upward and outward repelling force to the recessed enclosure 14, which is also used to adjust the height of the recessed enclosure 14 in relation to the surface level. Importantly the diagonal portion of the support spring engages the top and side of a surface 12, which enables the squeezing and upward and outward repelling force to the recessed enclosure 14. These forces are respectively a substantially vertical upward force between the recessed enclosure and the top of the surface and a substantially horizontal outwardly repelling force between the recessed enclosure and the side of the surface. The exemplary sidewall 16 of the recessed enclosure 14 is substantially vertical in shape and therefore the guide rail 44 is disposed substantially parallel relative to the recessed enclosure 14. The guide rail 44 is generally parallel relative to the recessed enclosure 14 but various angles may be utilized relative to the shape of the recessed enclosure 14. Along the guide rail 44 are at least one or a plurality of slots 56 to comprise the adjustment portion 50. The support spring 42 has at least one finger 52 at the first end 46. The support spring 42 may also include a back portion 54 to surround the guide rail 44 to help guide it thereon. The fingers 52 engage the adjustment portion's 50 slots 56 providing an upper position limiting feature for the captive retaining spring 40. The fingers 52 may also be any other mechanical structure such as screws, tabs, etc. to engage the slots 56. Accordingly, the combination of the position feature of the fingers 52/adjustment portion 50 and the squeezing and upward/outward force of the second elastic end 48 of the support spring 42 provide improved stability and retaining ability for the recessed enclosure 14 for a variety of surface 12 thicknesses.

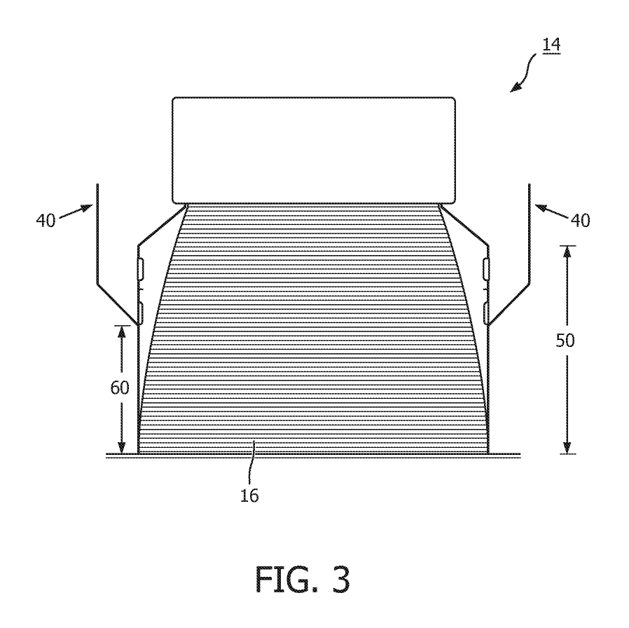

Referring now to FIG. 3, a perspective view of the recessed enclosure 14 is depicted showing the captive retaining spring 40 extending within the recessed lighting can sidewall 16. The recessed enclosure 14 comprises an adjustment area 60 which allows for vertical positioning adjustment of the spring 40. Consequently, such adjustment allows use with surfaces of varying thickness. The adjustment area 60 comprises an adjustment portion 50. The adjustment portion 50 comprises a plurality of adjustment slots 56 or apertures spaced apart on the side of the adjustment portion 50. Once installed, finger 52 of support spring 42 is retained within the slot 56. The slots 56 are substantially rectangular in shape but may comprise alternative shapes allowing the fingers 52 to extend there through. Thus, the fingers 52 in the first end 46 of the support spring 42 is disposed within the slot 56 and the fingers 52 may be positioned in the adjustment portion 50 of guide rail 44. A particular slot 56 can be chosen to properly adjust the recessed enclosure 14 to the proper height in relation to the surface. In addition, this design enables the spring 40 to inhibit vertical movement and the weight of the recessed enclosure 14 further creates a downforce on surface 12. The downforce also forcibly adjusts the second elastic end 48 of support spring 42 to further provide stability to the recessed enclosure 14 by the compression between second elastic end 48 and lower trim 20.

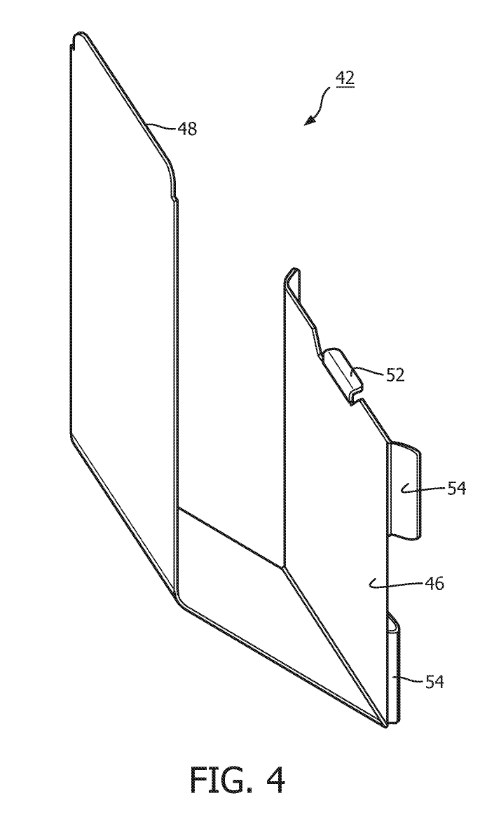

FIG. 4 is a perspective view of support spring of the captive retaining spring of FIG. 1. As described above, the support spring 42 has a least one finger 52 at the first end 46. The support spring 42 may also include a back portion 54 to surround/support the guide rail 44 to help guide it thereon. Upper portion of 54 is used to grab and pull to disengage finger from a slot and allows it to move up or down when finger is pulled away. Lower part of 54 hugs guide rail and allows upper 54 to flex. The fingers 52 engage the adjustment portion's 50 slots 56 providing an upper position limiting feature for the captive retaining spring 40. As one skilled in the art will recognize any or other mechanical detail to engage the adjustment portion in the guide rail, for example indents, and the like may be employed.

During installation of the recessed enclosure 14 to a surface aperture, it may be necessary to fold the captive retaining spring 40 of the recessed enclosure 14 to allow it to pass through the surface aperture. Once the captive retaining springs 40 engage, recessed enclosure 14 will pull itself upwards and outwards, with trim 20 providing an upper movement limit (e.g. to the surface 12 level).

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

While there has been shown, described, and pointed out fundamental and novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention.

It is expressly intended that all combinations of those elements that perform substantially the same function in substantially the same way to achieve the same results are within the scope of the invention. Substitutions of elements from one described embodiment to another are also fully intended and contemplated.

Any reference signs in the claims should not be construed as limiting the scope of the claims or the invention described by the subject matter claimed.

1. A recessed mounting assembly, comprising:
a recessed enclosure having a trim;
a retaining spring that is adjustable for retaining said recessed enclosure above a top portion of a surface, said retaining spring having a guide rail coupled to said trim, the guide rail having an adjustment portion;
a support spring having a first end adjustably coupled to the adjustment portion of the guide rail, and a second end having a diagonal portion extending outwardly from said first end, the second end being forcibly adjustable;
said retaining spring being adjustable using said first end of said support spring to engage or disengage adjustably along said adjustment portion of the guide rail to move said first end above said top portion of the surface and enable engagement of only said diagonal portion with said top portion of the surface with a squeezing force between said diagonal portion of said support spring and said trim, wherein said squeezing force pulls the recessed enclosure upwards and outwards from the top and a side of said surface.

2. The recessed mounting assembly of claim 1, wherein said retaining spring causes a force substantially parallel to the longitudinal axis of said recessed enclosure.

3. The recessed mounting assembly of claim 1, said spring applying force to a surface a spaced distance from a surface aperture edge.

4. The recessed mounting assembly of claim 1 further comprising at least one finger at the first end of said support spring.

5. The recessed mounting assembly of claim 1 further comprising a second trim, wherein said squeezing force at said second end of said support spring and said second trim provide a compression force to said recessed mounting assembly.

6. The recessed mounting assembly of claim 1, wherein the first end of said support spring is toollessly adjustable along said adjustment portion of the guide rail.

7. The recessed mounting assembly of claim 1, wherein the second end of said support spring extends in an outwardly diagonal direction in relation to the guide rail.

8. A surface mounting assembly for a recessed enclosure, comprising:
an enclosure having a trim;
a captive retaining spring that is adjustable for retaining said enclosure above a top portion of a surface, said captive retaining spring having a guide rail extending from said trim;
said captive spring being adjustable along said guide rail for use with various surface thicknesses;
said captive spring applying both a substantially vertical upward force between said enclosure and a top of a surface and a substantially horizontal outwardly repelling force between said enclosure and a side of a surface;
a support spring arm positioned on said guide rail, said support spring arm having fingers which engage at least one adjustment portion of said guide rail and an elastic portion to apply said substantially vertical and horizontal outwardly repelling retaining forces.

9. The surface mounting assembly of claim 8, further comprising a second trim, wherein said vertical retaining force at said second end of said support spring and said second trim provide a compression force to said recessed mounting assembly.

10. The surface mounting assembly of claim 8, wherein the guide rail extends from the trim to the second trim.

11. The surface mounting assembly of claim 8, wherein the support spring arm is positioned on said guide rail toollessly.

12. The surface mounting assembly of claim 8, wherein said first end of said support spring being adjustable in a vertical direction.

13. The surface mounting assembly of claim 8, wherein said elastic portion of said support spring extends in an outwardly diagonal direction in relation to the guide rail.
